(19) United States
(12) Patent Application Publication
(10) Pub. No.: US 2005/0280911 A1
(43) Pub. Date: Dec. 22, 2005

(54) Color wheels

(75) Inventors: Sean Huang, Taoyuan Hsien (TW); Sean Chang, Taoyuan Hsien (TW)

Correspondence Address: BIRCH, STEWART, KOLASCH & BIRCH, LLP, PO BOX 747, 8110 GATEHOUSE RD, STE 500 EAST, FALLS CHURCH, VA, 22040-0747, US

(73) Assignee: Delta Electronics, Inc.

(21) Appl. No.: 10/984,901

(22) Filed: Nov. 10, 2004

(30) Foreign Application Priority Data
Jun. 18, 2004 (TW) 93117621

(51) Int. Cl. G02B 5/22

(52) U.S. Cl. 359/891

(57) ABSTRACT

Color wheels are provided. An exemplary embodiment of a color wheel, for optical projection, has an optical axis and includes a plurality of color rings, comprising a plurality of color filters. At least one color ring includes a white permeable area. The color rings move on a plane perpendicular to the optical axis, so that the optical axis passes through one of the color rings.

### BACKGROUND

The invention relates to color wheels and more particularly, to color wheels used in optical projections.

According to different requirements, optical projection systems are usually divided into multi-media protection and data projection. The difference between the mentioned projections is use of different color wheels. For data projection, requiring high brightness, the color wheel has a white permeable area enabling a light beam to pass through completely, as shown in FIG. 1A. For multimedia protection, focusing on color representation, the color wheel does not have the white permeable area, as shown in FIG. 1B.

However, in data projection, overall brightness increase sacrifices color saturation. In multimedia protection, the opposite is true. Due to different color wheel designs, it is difficult to interchange them, such that, when a projection system is designed for data projection, it is unsuitable for use with multimedia protection.

### SUMMARY

Color wheels are provided. An exemplary embodiment of a color wheel comprises a first color ring and a second color ring. The first color ring comprises a plurality of color filters. The second color ring comprises a plurality of color filters and a white permeable area. The first and second color rings move on a plane perpendicular to an optical axis passing through one of the color rings.

Some embodiments of a color wheel comprise a first color ring, a second color ring, and a third color ring. The first color ring comprises a plurality of color filters and a first white permeable area. The second color ring comprises a plurality of color filters and a second white permeable area. The third color ring comprises a plurality of color filters. The first, second, and third color rings move on a plane perpendicular to an optical axis passing through one of the color rings.

Some embodiments of a color wheel comprise a plurality of color rings comprising a plurality of color filters and a first white permeable area on at least one of the color rings. The color rings move on a plane perpendicular to an optical axis passing through one of the color rings

### DESCRIPTION OF THE DRAWINGS

FIG. 1A is a schematic diagram of a conventional color wheel for data projection;

FIG. 1B is a schematic diagram of a conventional color wheel for multimedia projection;

FIG. 2A is a schematic diagram of an embodiment of a color wheel;

FIG. 2B is a schematic diagram of an embodiment of a color wheel;

FIG. 3A is a schematic diagram of the relationship between an optical axis and the color wheel in FIG. 2A;

FIG. 3B is a schematic diagram of the relationship between an optical axis and the color wheel in FIG. 2B; and

FIG. 4 is a schematic diagram of an embodiment of a color wheel.

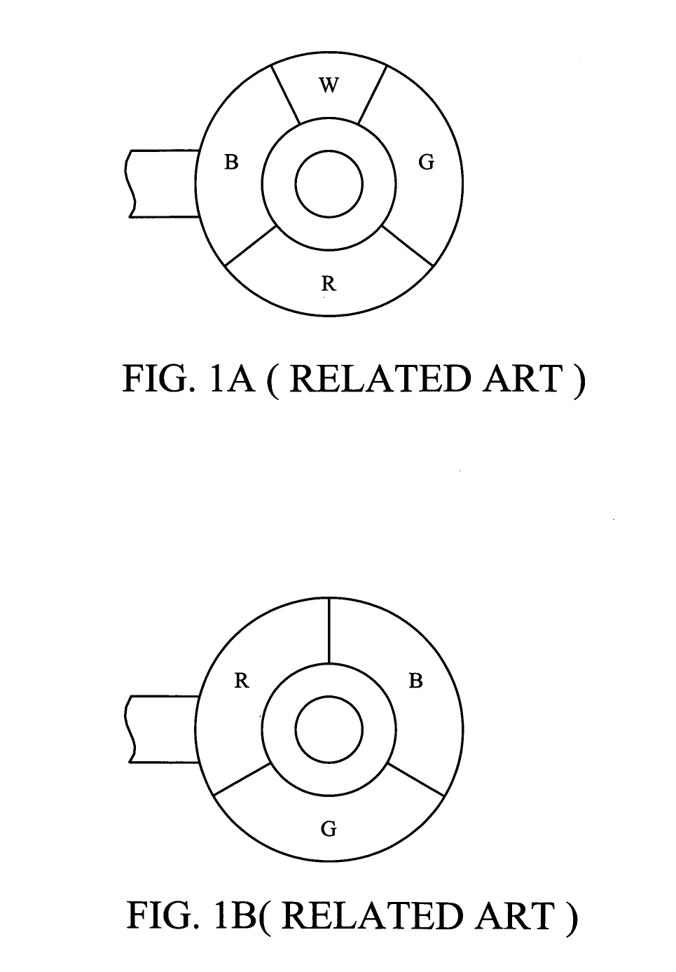

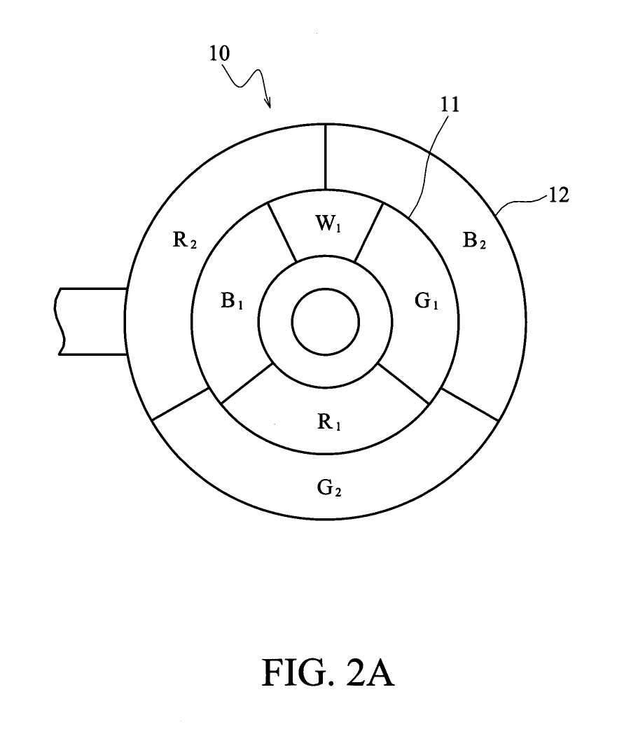

### DETAILED DESCRIPTION

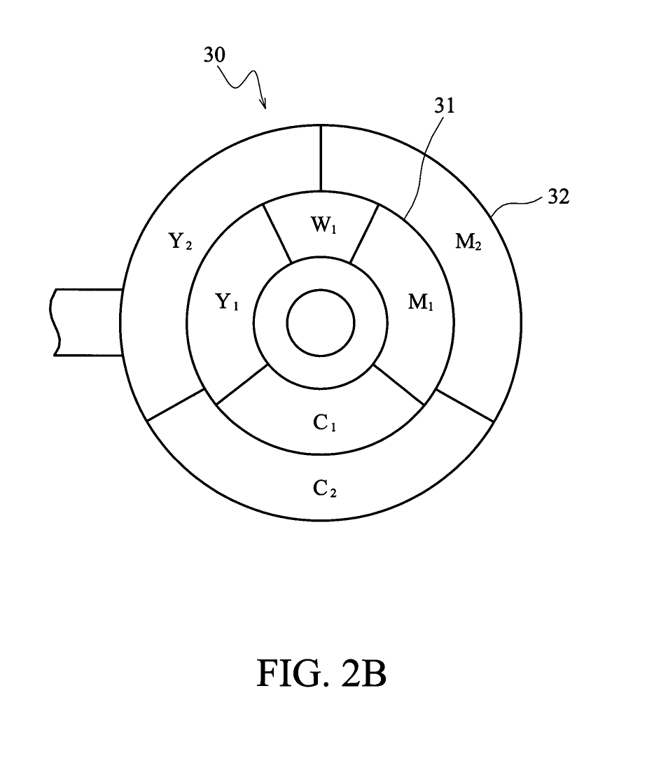

Color wheels are provided. FIG. 2A indicates an exemplary embodiment of a color wheel 10 comprising a first color ring 11 and a second color ring 12. The first color ring 11 comprises a red filter R1, a blue filter B1, a green filter G1, and a white permeable area W1. The area of the white permeable area W1 is less than that of anyone of the color filters. The second color ring 12 comprises a red filter R2, a blue filter B2, and a green filter G2.

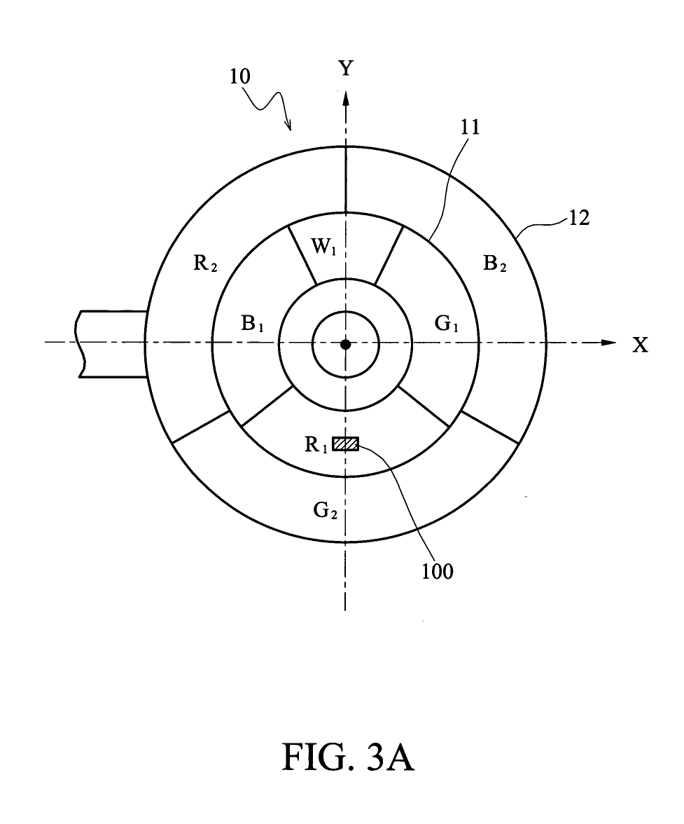

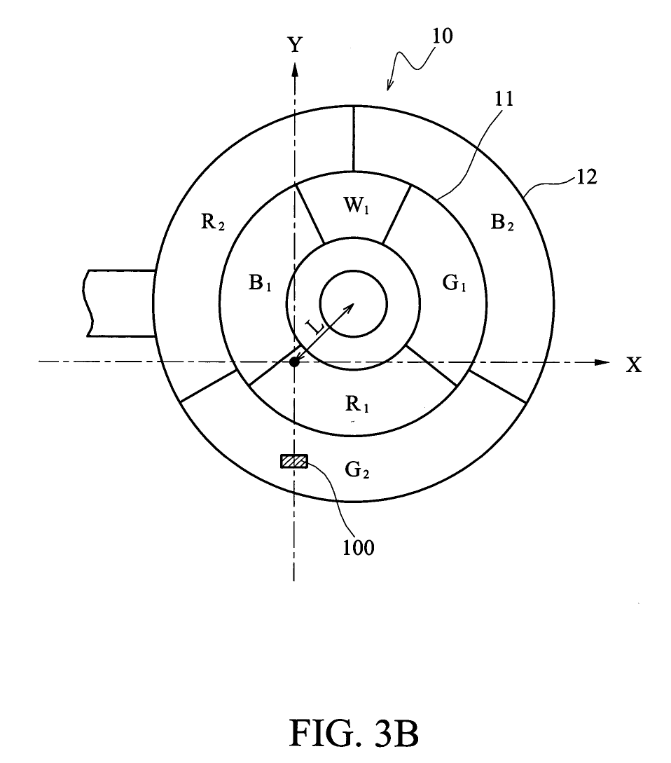

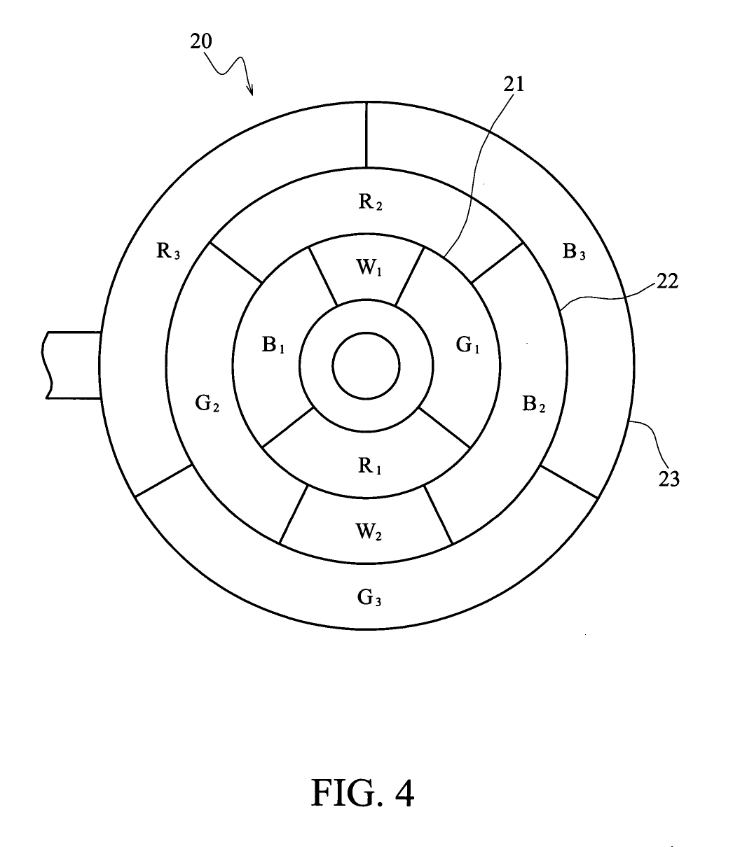

Referring to FIGS. 3A and 3B, the color wheel 10 move on a plane (the X-Y plane as shown in FIGS. 3A and 3B) perpendicular to an optical axis of an optical projection system (not shown), such that an axial projection surface 100 is capable of projecting on either color ring of the color wheel 10. Namely, the optical axis passes through either color ring of the color wheel 10, so that the optical projection system switches between data and multimedia projection, accordingly. For example, if data projection is desired, the axial projection surface 100 is projected onto the first color ring 11 such as the center of the color wheel 10, positioned at the center of the X-Y plane, as shown in FIG. 3A. If multimedia projection is then required, the center of color wheel 10 is shifted a predetermined distance L1 according to the center of the X-Y plane such that the axial projection surface 100 is projected onto the second color ring 12, as shown in FIG. 3B.

FIG. 2B shows a color wheel 30 comprising a first color ring 31 and a second color ring 32. The first color ring 31 comprises a white permeable area W1, a cyan filter C1, a magenta filter M1, and a yellow filter Y1. The second color ring 32 comprises a cyan filter C2, a magenta filter M2, and a yellow filter Y2, creating on the first and second color rings, complementary filtering of red, green, and blue respectively, differing in color effect from color wheel 10 of the first embodiment. Operation of the color wheel 30 of this similar to the first embodiment, and is thus omitted.

FIG. 4 shows a color wheel 20 comprising a first color ring 21, a second color ring 22, and a third color ring 23. The first color ring 21 comprises a red filter R1, a blue filter B1, a green filter G1, and a white permeable area W1. The second color ring 22 comprises a red filter R2, a blue filter B2, a green filter G2, and a white permeable area W2. The third color ring 23 comprises a red filter R3, a blue filter B3, and a green filter G3. The area of white permeable area W1 is different from that of white permeable area W2. For example, the white permeable area W1 on the first color ring 21 may be smaller than the white permeable area W2 on the second color ring 22. Furthermore, the color of the color filters is not limited to red, green, and blue, and can be cyan, magenta, and yellow, or any other color.

Similarly, the color wheel 20 moves on a plane perpendicular to an optical axis of an optical projection system (not shown), such that an axial projection surface is capable of projecting on each one color ring of the color wheel 20, so that the optical projection system switches in different types. In this embodiment, the optical projection system is in a first data projection mode when the axial projection surface is projected on the first color ring 21, a second data projection mode when the axial projection surface is projected on the second color ring 22, and a multimedia projection mode when the axial projection surface is projected on the third color ring 23. Brightness in the second data projection mode exceeds that in the first data projection mode. The operation of the color wheel 20 in this embodiment is similar to the first embodiment, and is thus omitted.

While the invention has been described by way of example and in terms of preferred embodiments, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A color wheel for optical projection, comprising:
a first color ring comprising a plurality of color filters; and
a second color ring comprising a plurality of color filters and a white permeable area;
wherein the first and second color rings move on a plane perpendicular to an optical axis, the optical axis passing through one of the first and second color rings.

2. The color wheel as claimed in claim 1, wherein the number of color filters on the first color ring is the same as the number of color filters on the second color ring.

3. The color wheel as claimed in claim 2, wherein the number of color filters on the first and second color rings is three.

4. The color wheel as claimed in claim 3, wherein the color filters on the first color ring comprises red, green and blue respectively.

5. The color wheel as claimed in claim 4, wherein the color filters on the second color ring comprises red, green and blue respectively.

6. The color wheel as claimed in claim 3, wherein the color filters on the first color ring comprises cyan, magenta and yellow respectively.

7. The color wheel as claimed in claim 6, wherein the color filters on the second color ring comprises cyan, magenta and yellow respectively.

8. The color wheel as claimed in claim 1, wherein the area of the white permeable area is smaller than the area of each color filter on the second color ring.

9. A color wheel for optical projection system, comprising:
a first color ring comprising a plurality of color filters and a first white permeable area;
a second color ring comprising a plurality of color filters and a second white permeable area; and
a third color ring comprising a plurality of color filters;
wherein the first, second, and third color rings move on a plane perpendicular to an optical axis, the optical axis passing through one of the first, second, and third color rings.

10. The color wheel as claimed in claim 9, wherein the number of color filters on the first, second, and third color rings are the same.

11. The color wheel as claimed in claim 10, wherein the color filters on the first color ring comprises red, green and blue respectively.

12. The color wheel as claimed in claim 11, wherein the color filters on the second color ring comprises red, green and blue respectively.

13. The color wheel as claimed in claim 12, wherein the color filters on the third color ring comprises red, green and blue respectively

14. The color wheel as claimed in claim 10, wherein the color filters on the first color ring comprises cyan, magenta and yellow respectively.

15. The color wheel as claimed in claim 14, wherein the color filters on the second color ring comprises cyan, magenta and yellow respectively.

16. The color wheel as claimed in claim 15, wherein the color filters on the third color ring comprises cyan, magenta and yellow respectively

17. The color wheel as claimed in claim 9, wherein the area of the first white permeable area on the first color ring is smaller than the area of the second white permeable area on the second color ring.

18. A color wheel for optical projection, comprising:
a plurality of color rings comprising a plurality of color filters and a white permeable area formed on at least one of the color rings;
wherein the color rings move on a plane perpendicular to an optical axis, the optical axis passing through one of the color rings.

19. The color wheel as claimed in claim 18, wherein the color filters comprise red, green and blue.

20. The color wheel as claimed in claim 18, wherein the color filters comprise cyan, magenta and yellow.
